(19) United States
(12) Patent Application Publication
(10) Pub. No.: US 2018/0181141 A1
(43) Pub. Date: Jun. 28, 2018

(54) ROBOT SURVEILLANCE SYSTEM

(71) Applicant: H.P.B OPTOELECTRONIC CO., LTD, Taichung City (TW)

(72) Inventors: Hsuan-Yueh Hsu, Taichung City (TW); Wei-Siang Fu, Taichung City (TW); Yi-Hsing Lin, Taichung City (TW)

(21) Appl. No.: 15/855,873

(22) Filed: Dec. 27, 2017

(30) Foreign Application Priority Data
Dec. 28, 2016 (TW) 105143466

(51) Int. Cl. G05D 1/02; H04N 7/18; H04N 5/225; G06T 7/20; G06K 9/62

(52) U.S. Cl. CPC G05D 1/0248; H04N 7/185; H04N 5/2256; H04W 4/80; G06T 7/20; G06K 9/6202; G05D 1/0214; H04N 5/2254

(57) ABSTRACT

Disclosed is a robot surveillance system for preventing a robot from falling down or collision by means of dynamic detection of moving object invasion. The system includes a light-emitting unit, an image capture unit, an image processing unit, a turning control unit, and a wireless transceiver unit. The image capture unit combines with an optic pattern to provide a visual module for the moving or surveillance robot. The shape of the optic pattern changes as the robot moves toward the object or pothole, and the image processing unit recognizes the detected object to be standstill, and thus controls the moving direction of the robot to effectively avoid falling or collision. Any moving object in the space is detected by the object motion detection, thereby effectively achieving the goal of spatial surveillance and security.

### CROSS-REFERENCE TO RELATED APPLICATION

This application claims the priority of Taiwanese patent application No. 105143466, filed on Dec. 28, 2016, which is incorporated herewith by reference.

### BACKGROUND OF THE INVENTION

### 1. Field of the Invention

The present invention generally relates to a robot surveillance system, and more specifically to a robot surveillance system for controlling a proceeding direction of a robot by detecting change of the specific optic pattern on an object to implement a function of spatial security and surveillance.

### 2. The Prior Arts

The clean robot in the prior arts is an automatic clean device, which freely moves without any control of the user. For example, the clean robot can move around the indoor space like house or office to remove dirty stuff (such as trash or dust) on the ground to the built-in container or box so as to implement effect of clean indoor environment. Thus, the clean robot gradually becomes a must for the modern married couple working and busy all day. However, the traditional clean robot has some limitations in use. For example, all pieces of the indoor furniture are placed at various locations dependent on the user, and the arraignment possibly changes over time. If the indoor space has a structure of ladder or regions with different heights, and the clean path of the clean robot is not updated, the clean robot still moves along the preset clean route and fails to implement effective cleaning for all preset regions. Or, the clean robot might even fall down or collide with surrounding stuffs. Thus, many researches trying to solve the problem of the proceeding course for the clean robot have been provided. One of the most popular utilizes a block device (or so called a virtual wall) to control the clean robot to turn. Specifically, the virtual wall transmits a block signal, and the clean robot receives the block signal to move backward or obliquely so as to avoid collision or falling down.

While the above method can prevent the clean robot from colliding with the surrounding object or falling down from the ladder, it is another problem that if a gap between two objects is wide enough for the clean robot to pass, the clean robot still moves into the gap between two objects, but fails to find the correct path to leave the gap. To solve this problem, the robot is provided with a plurality of cameras or ultrasonic wave sensors to determine the objects in front. However, the ultrasonic wave sensor fails to effectively determine if any slight bump object like an electric wire or network cable is placed on the floor. As a result, the robot easily gets entangled and tightly stuck by the wire. Particularly, the ultrasonic wave sensor is expensive, and the process of installation is quite complicated.

### SUMMARY OF THE INVENTION

The primary objective of the present invention is to provide a robot surveillance system, and more specifically to a robot surveillance system for controlling a traveling direction of a robot by detecting change of the specific optic pattern on an object to implement a function of spatial security and surveillance. The robot surveillance system of the present invention utilizes a specific hardware to incorporate the image capture unit with the optic pattern emitted by the light-emitting unit for providing the robot with the visual module. In other words, the optic pattern according to the image captured by the image capture unit changes because the robot is moving and about to collide with the standstill object like a hump or recess, the image processing unit recognizes and confirms that the standstill object is present, and controls the robot to turn so as to instantly avoid collision or falling down. In particular, the present invention can detect the moving object in the space by means of motion detection to effectively implement spatial security and surveillance, thereby greatly decreasing cost of hardware and manpower, improving precision of detection and surveillance, and providing instant warning.

To fully meet the above objective, the present invention provides a robot surveillance system, comprising a system server, a communication network, and a plurality of client devices. The at least one light-emitting unit is provided on an outer part of a robot, and each light-emitting unit emits a light beam, which comprises an optical pattern incident on and shown by at least one standstill object or at least one moving object in space. In particular, the optical pattern changes dependent on the standstill object or the moving object. The image capture unit is provided on the outer part of the robot, and comprises an optic lens and a photo-sensing device connected together. The optic lens captures an image of the standstill or moving object to cause the photo-sensing device to form a captured image of the optical pattern from the standstill or moving object. The image processing unit is electrically connected to the image capture unit for receiving the captured image of the image capture unit. The image processing unit comprises a detection module, a recognition module, and a motion detection module. The detection module detects the optic pattern from the image capture unit. When the optic pattern changes due to the standstill object, a distance away from the standstill object is calculated and a first signal is generated and transferred. When a comparison result of the image showing not consistent is confirmed by the recognition module examining and comparing information of the image from the image capture unit, a second signal is generated and transferred. When the motion detection module detects the moving object in the image, a third signal is generated and transferred. The turning control unit is electrically connected to the detection module for receiving the first signal of the detection module to control the robot to turn to avoid the standstill object. The wireless transceiver unit is electrically connected to the recognition module and the motion detection module for receiving the image, the second signal, and the third signal from the recognition module and the motion detection module to wireless transfer to a user at a remote surveillance device through a wireless communication protocol.

As mentioned above for the system of the present invention, the at least one light-emitting unit is one of a laser, a light-emitting diode, and a luminary for emitting the light beam.

Also, the optic pattern is one of a grid, a straight line, and dots regularly arranged.

The standstill object is at least one of an object placed on the ground, a recess of the ground, and a hump of the ground.

The optic lens is one of a fish-eye lens, a wide-angle lens, and a standard lens.

The photo-sensing device is one of a charge coupled device (CCD) and a complementary metal oxide semiconductor (CMOS).

The recognition mode reads the information of the image through means of face recognition, bar code recognition, or pattern recognition, and compares with a plurality of built-in comparison data in the recognition module.

The recognition module further comprises a store module for storing the plurality of built-in comparison data.

The motion detection module employs means of object motion detection, light flow detection, or object outline detection to detect the moving object.

The communication protocol is at least one of Bluetooth communication protocol, infrared communication protocol, near-field communication (NFC), wireless local area networks (WLAN), WiGig, Zigbee, Wireless USB, ultra-wide band (UWB), and WiFi for providing the wireless transceiver unit with a function of communication with the remote surveillance device.

The remote surveillance device is one of a mobile communication device, a remote device, and a computer device.

The light-emitting unit is a flickering light source, having a flickering frequency the same as an image capture frequency of the image capture unit.

The detection module of the image processing unit examines and compares differences between two successive images captured by the image capture unit to identify change of the optic pattern.

With this, the robot surveillance system of the present invention utilizes the specific hardware to incorporate the image capture unit with the optic pattern emitted by the light-emitting unit for providing the clean robot with the visual module. That is, the optic pattern according to the image captured by the image capture unit changes because the clean robot is moving and about to collide with the standstill object like a hump or recess, the image processing unit recognizes and confirms that the standstill object is present, and controls the robot to turn so as to instantly avoid collision or falling down. Thus, the present invention overcomes the issue that the traditional robot needs expensive laser radar or ultrasonic wave to avoid collision, and implements the advantage of cost down for hardware. Additionally, the robot surveillance system of the present invention provides the image capture unit and the at least light-emitting unit emitting the optic pattern in pair as the surveillance module of various robots, and monitors at least one moving object by means of motion object detection, light flow detection, and object outline detection so as to effectively implementing spatial security and image transfer. As a result, the advantage of more precise detection/surveillance and instant warning is achieved. Further, the present invention employs means of image capture, detection, and identification like face recognition, bar code recognition, or pattern recognition to deeply patrol around the large scale factory or the residence building, and identify the strangers invading the factor or the building. Thus, the advantages of reducing of the manpower cost of security and instantly informing/warning are obtained. Finally, the present invention utilizes the change of the optic pattern emitted by the light-emitting unit to detect any object on the ground like electric wire or cable, thereby effectively overcoming the problem that the traditional clean robot fails to exactly detect the height of the hump on the ground and gets stuck, leading to waste lots of power. It is obvious the present invent can avoid any obstacle on the ground and save power consumption.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a view showing the functional blocks of the robot surveillance system according to the embodiment of the present invention; and

FIG. 2 is a view showing one exemplary application of the robot surveillance system of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

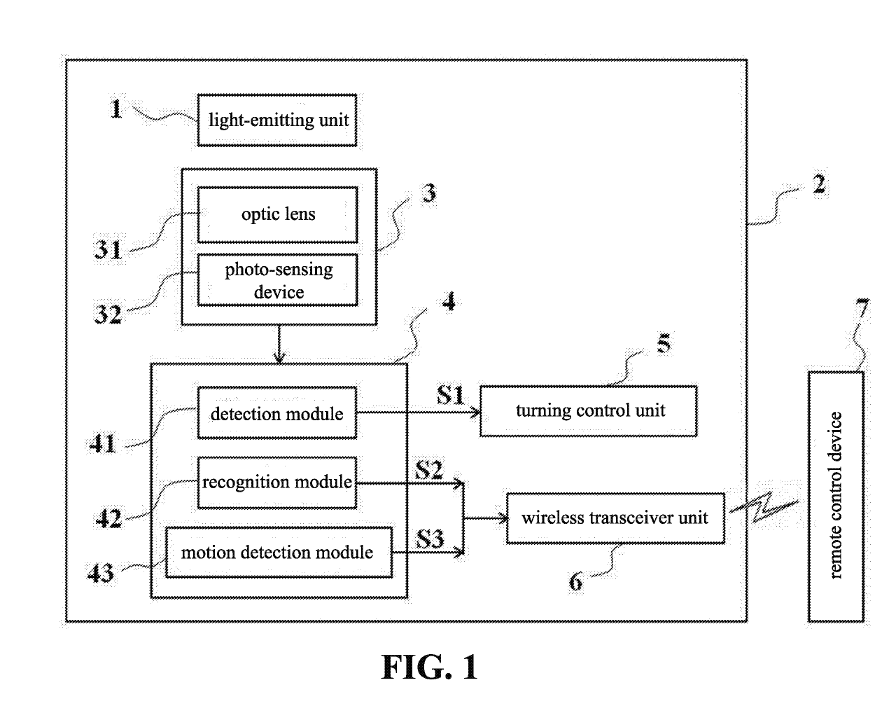

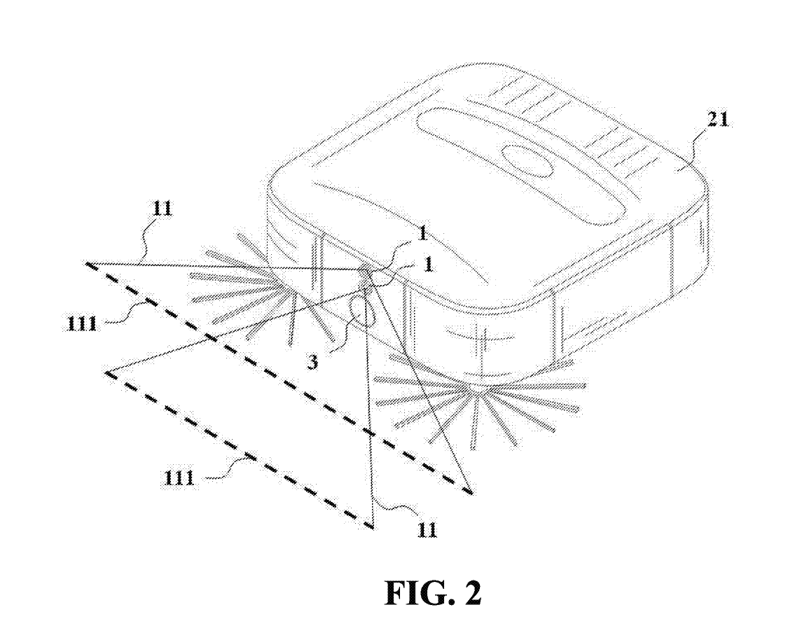

Please refer to FIGS. 1 and 2 illustrating functional blocks and one exemplary application of the robot surveillance system according to the embodiment of the present invention, respectively. The robot surveillance system of the present invention is intended to prevent a robot 2 from falling down or collision by detecting change of an optic pattern 111, and implement detection of at least one moving object invading the concerned region in space to achieve the aim of security and surveillance. In one embodiment of the present invention, the robot 2 is but not limited to a cleaning robot 21 for cleaning the indoor environment of a house or office, and security/surveillance. In addition, in another embodiment of the present invention, the robot 2 is but not limited to a patrol robot for patrolling around a building or a large scale factory, and further monitoring any undesired person invading the specific region. Specifically, the robot surveillance system of the present invention generally comprises at least one light-emitting unit 1, an image capture unit 3, an image processing unit 4, a turning control unit 5, and a wireless transceiver unit 6.

The at least one light-emitting unit 1 is provided on the outer part of the robot 2, and each light-emitting unit 1 emits a light beam 11 comprising an optical pattern 111, which is incident on and shown by at least one standstill object or at least one moving object in space. The optical pattern will change dependent on the standstill object or the moving object. In addition, the at least one light-emitting unit 1 is one of a laser, a light-emitting diode, and a luminary for emitting the light beam. Also, the optic pattern 11 is one of a grid, a straight line, and dots regularly arranged, and the standstill object is at least one of an object placed on the ground, a recess of the ground, and a hump of the ground. In one embodiment of the present invention, the cleaning robot 21 is implemented by a robot 2, which has an outer provided with two adjacent lasers as the light-emitting units 1. Specifically, the two light beams 11 emitted by two lasers comprises the optic patterns like straight lines. Further, one of the two light beams 11 horizontally travels forward in parallel such that the object standing on the ground or a hump of the ground as the standstill object is detected by use of the straight line pattern. The other light beam 11 of the light-emitting unit 1 oblique travels toward the ground such that the standstill object standing in a recess of the ground is detected by use of the straight line pattern. However, it should be noted that the above standstill objects and the optic patterns 111 are only exemplary for clear explanation, and not intended to limit the scope of the present invention. For those who skilled in this technical field, all the types of the optic pattern 111 performing the similar feature of the present invention are thus included in the scope of the present invention.

The image capture unit 3 is provided on the outer part of the robot 2, and comprises an optic lens 31 and a photo-sensing device 32 connected to the optic lens 31. The optic lens 31 is configured to capture an image of the standstill or moving object to cause the photo-sensing device 32 to form a captured image based on the optical pattern from the standstill or moving object. Further, the optic lens 31 is one of a fish-eye lens, a wide-angle lens, and a standard lens, and the photo-sensing device 32 is one of a charge coupled device (CCD) and a complementary metal oxide semiconductor (CMOS). In the embodiment of the present invention, the optic lens 31 and the photo-sensing device 32 are implemented by the fish-eye lens and the CCD, respectively. The image capture unit 3 is provided on the outer part of the robot 2 with respect to the light-emitting unit 1, and the image of the optic pattern 111 is formed on the photo-sensing device 32.

The image processing unit 4 is electrically connected to the image capture unit 3 for receiving the image captured by the image capture unit 3, and comprises a detection module 41, a recognition module 42, and a motion detection module 43 The detection module 41 detects the optic pattern 111 in the image. When the optic pattern 111 changes due to the standstill object, a distance away from the standstill object is calculated and a first signal S1 is generated and transferred by the detection module 41. The recognition module 42 examines and compares information of the image from the image capture unit 3. When a comparison result of the image shows not consistent, the recognition module 42 generates and transfers a second signal S2. The motion detection module 43 detects the moving object in the image to generate and transfer a third signal S3. Moreover, the recognition mode 42 reads the information of the image through means of face recognition, bar code recognition, or pattern recognition, and compares with a plurality of built-in comparison data in the recognition module 42. The recognition mode 42 further comprises a store module (not shown) for storing the plurality of built-in comparison data. The motion detection module 43 employs means of object motion detection, light flow detection, or object outline detection to detect the moving object. In the embodiment of the present invention, the detection module 41 of the image processing unit 4 is configured for receiving the image captured by the image capture unit 3, and determines if the optic pattern 111 is incident on the standstill object and thus changes. If the optic pattern 111 changes, the detection module 41 issues the first signal S1 and calculates the distance away from the standstill object. For example, the detection module 42 is suitably applicable to the patrol robot of the second embodiment. When the patrol robot is configured to patrol the residence building or the large scale factory, means of bar code identification is employed to compare the built-in comparison data with the bar code on the person like employee ID. When the comparison result shows not consistent, the recognition module 42 transfers the person's image and the second signal S2, and at the same time, the motion detection module 43 utilizes means of light flow detection to implement the goal of security and surveillance by detecting the moving object in the space invading the secured region, and then transfers the image and the third signal S3.

The turning control unit 5 is electrically connected to the detection module 41 for receiving the first signal S1 of the detection module 41 to control the robot 2 to correctly turn to avoid the detected standstill object. In the embodiment of the present invention, when the detection module 41 receives the captured image from the image capture unit 3 and confirms that the optic pattern 111 incident on the standstill object changes, the detection module 41 issues the first signal S1 to the turning control unit 5, thereby controlling the robot 2 to appropriately turn and preventing risk of colliding with the standstill object.

The wireless transceiver unit 6 is electrically connected to the recognition module 42 and the motion detection module 43. Specifically, the wireless transceiver unit 6 receives the image, the second signal S2, and the third signal S3 from the recognition module 42 and the motion detection module 43 to wireless transfer to a user at a remote surveillance device 7 through a wireless communication protocol. Additionally, the communication protocol is at least one of Bluetooth communication protocol, infrared communication protocol, near-field communication (NFC), wireless local area networks (WLAN), WiGig, Zigbee, Wireless USB, ultra-wide band (UWB), and WiFi for providing the wireless transceiver unit 6 with a function of communication with the remote surveillance device 7. Moreover, the remote surveillance device 7 is one of a mobile communication device, a remote device, and a computer device. In the embodiment of the present invention, when the recognition module 42 confirms the comparison result is not consistent, the image of the undesired person and the second signal S2 are transferred, and the wireless transceiver unit 6 employs the wireless communication protocol to further transfer the image and the second signal S2 to the mobile communication device by the user as the remote surveillance device 7 so as to warn or inform related persons of the situation that the residence building or the factory is invaded by some undesired person. Further, when the motion detection module 43 uses means of light flow detection to detect the moving object in the space, the image and the third signal S3 are transferred to the wireless transceiver 6. Then, the wireless transceiver 6 further transfers the image of the moving object to the remote surveillance device 7 of the user, thereby informing the related persons of the invasion event caused by the moving object, and at the same time, storing the image of the moving object.

Furthermore, the light-emitting unit 1 is a flickering light source having a flickering frequency, which is the same as an image capture frequency of the image capture unit 3. Also, the detection module 41 of the image processing unit 4 examines and compares the differences between two successive images captured by the image capture unit 3 to identify change of the optic pattern 111. In the third embodiment of the present invention, when the light emitted by the light-emitting unit 1 in the flicker mode is kept bright, the image capture unit 3 fetches one image of the standstill object and the optic pattern 111 on the standstill object, and when the light emitted light turns dark at the next moment, the current image of the standstill object and the optic pattern 111 is fetched. The detection module 41 performs subtraction of the above two successive images to extract only the part of the optic pattern 111 in the image for more precisely detecting and identifying the change of the optic pattern 111 and more strictly controlling the robot 2 to turn.

Next, some actual applications for the robot surveillance system are described below to further help well understand the key features provided by the present invention, but not limited to the scope of the present invention. When the user intends to clean the area, the clean robot 21 provided with the robot surveillance system of the present invention is helpful because the clean robot 21 is prevented from colliding with some standstill object or falling down. Further, the clean robot 21 can surely monitor the moving object in the space by means of motion detection to effectively performing security and surveillance of the desired region, thereby providing the advantage of greatly decreasing cost of hardware and manpower, improving precision of detection and surveillance, and implementing instant warning. First, the at least one light-emitting unit 1 is prepared, and provided on the outer part of the robot 2. Each light-emitting unit 1 implemented by the laser emits a laser beam 11 comprising the specific optical pattern 111, which is incident on and shown by at least one standstill object or at least one moving object in space. As a result, the optic pattern 111 changes due to the standstill object or the moving object. Then, the image capture unit 3 is prepared and provided on the outer part of the robot 2. The image capture unit 3 comprises the optic lens 31 and the photo-sensing device 32 connected together. The optic lens 31 is intended to capture the image of the standstill or moving object to cause the photo-sensing device 32 to form the captured image of the optical pattern 111 on the standstill or moving object. Next, the image processing unit 4 electrically connected to the image capture unit 3 is prepared. The detection module 41 of the image processing unit 4 detects and identifies the optic pattern 111 transferred from the image capture unit 3. When the optic pattern 111 changes due to the standstill object, the distance away from the standstill object is calculated and the first signal S1 is thus generated and transferred to the turning control unit 5 so as to correctly control the robot 2 to turn and avoid the standstill object. Finally, the motion detection module 43 built-in by the image processing unit 4 is prepared. When the moving object in the space is detected by the motion detection module 43 through means of light flow detection, the image and the third signal S3 are transferred to the wireless transceiver unit 6. Then, the wireless transceiver unit 6 transfers the received image to the remote surveillance device 7 employed by the user, like the mobile communication device, so as to inform the related persons of the information that invasion is resulted in by the moving object and instantly store the image. With this, a specific hardware is designed by the system of the present invention to incorporate the image capture unit 3 with the optic pattern 111 emitted by the light-emitting unit 1, and intended to provide the clean robot 21 with the visual module. In other words, when the optic pattern 111 according to the image captured by the image capture unit 3 changes because the clean robot 21 is moving and about to collide with the standstill object, the image processing unit 4 recognizes and confirms that the standstill object is present, and controls the clean robot 21 to turn so as to instantly avoid collision or falling down. Therefore, the advantage of greatly decreasing cost of hardware is indeed implemented.

From the above mention, it is obvious that the robot surveillance system of the present invention indeed implements the desired effects through the above embodiments, and is not disclosed before the application date, thereby meeting all the regulations of the patent law.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A robot surveillance system, comprising:
at least one light-emitting unit provided on an outer part of a robot, each light-emitting unit emitting a light beam comprising an optical pattern incident on and shown by at least one standstill object or at least one moving object in space changing, the optical pattern changing dependent on the standstill object or the moving object;
an image capture unit provided on the outer part of the robot, comprising an optic lens and a photo-sensing device connected together, the optic lens capturing an image of the standstill or moving object to cause the photo-sensing device to form a captured image of the optical pattern from the standstill or moving object;
an image processing unit electrically connected to the image capture unit for receiving the captured image of the image capture unit, the image capture unit comprising a detection module, a recognition module, and a motion detection module, the detection module detecting the optic pattern from the image capture unit, a distance away from the standstill object calculated and a first signal generated and transferred when the optic pattern changes due to the standstill object, the recognition module examining and comparing information of the image from the image capture unit, and generating and transferring a second signal when a comparison result of the image showing not consistent, the motion detection module detecting the moving object in the image to generate and transfer a third signal;
a turning control unit electrically connected to the detection module for receiving the first signal of the detection module to control the robot to turn to avoid the standstill object; and
a wireless transceiver unit electrically connected to the recognition module and the motion detection module for receiving the image, the second signal, and the third signal from the recognition module and the motion detection module to wireless transfer to a user at a remote surveillance device through a wireless communication protocol.

2. The robot surveillance system as claimed in claim 1, wherein the at least one light-emitting unit is one of a laser, a light-emitting diode, and a luminary for emitting the light beam.

3. The robot surveillance system as claimed in claim 1, wherein the optic pattern is one of a grid, a straight line, and dots regularly arranged.

4. The robot surveillance system as claimed in claim 1, wherein the standstill object is at least one of an object placed on the ground, a recess of the ground, and a hump of the ground.

5. The robot surveillance system as claimed in claim 1, wherein the optic lens is one of a fish-eye lens, a wide-angle lens, and a standard lens.

6. The robot surveillance system as claimed in claim 1, wherein the photo-sensing device is one of a charge coupled device (CCD) and a complementary metal oxide semiconductor (CMOS).

7. The robot surveillance system as claimed in claim 1, wherein the recognition mode reads the information of the image through means of face recognition, bar code recognition, or pattern recognition, and compares with a plurality of built-in comparison data in the recognition module.

8. The robot surveillance system as claimed in claim 7, wherein the recognition module further comprises a store module for storing the plurality of built-in comparison data.

9. The robot surveillance system as claimed in claim 1, wherein the motion detection module employs means of object motion detection, light flow detection, or object outline detection to detect the moving object.

10. The robot surveillance system as claimed in claim 1, wherein the communication protocol is at least one of Bluetooth communication protocol, infrared communication protocol, near-field communication (NFC), wireless local area networks (WLAN), WiGig, Zigbee, Wireless USB, ultra-wide band (UWB), and WiFi for providing the wireless transceiver unit with a function of communication with the remote surveillance device.

11. The robot surveillance system as claimed in claim 10, wherein the remote surveillance device is one of a mobile communication device, a remote device, and a computer device.

12. The robot surveillance system as claimed in claim 1, wherein the light-emitting unit is a flickering light source, having a flickering frequency the same as an image capture frequency of the image capture unit.

13. The robot surveillance system as claimed in claim 12, wherein the detection module of the image processing unit examines and compares differences between two successive images captured by the image capture unit to identify change of the optic pattern.
